(19) United States
(12) Patent Application Publication
(10) Pub. No.: US 2017/0022396 A1
(43) Pub. Date: Jan. 26, 2017

(54) ADHESIVE AGENT COMPOSITION FOR OPTICAL FILMS, ADHESIVE AGENT LAYER FOR OPTICAL FILMS, OPTICAL FILM HAVING ADHESIVE AGENT LAYER ATTACHED THERETO, AND IMAGE DISPLAY DEVICE

(71) Applicant: NITTO DENKO CORPORATION, Ibaraki-shi, Osaka (JP)

(72) Inventors: Tomoyuki Kimura, Ibaraki-shi (JP); Satoshi Yamamoto, Ibaraki-shi (JP); Masakuni Fujita, Ibaraki-shi (JP); Yuusuke Toyama, Ibaraki-shi (JP)

(73) Assignee: NITTO DENKO CORPORATION, Ibaraki-shi, Osaka (JP)

(21) Appl. No.: 15/301,194

(22) PCT Filed: Mar. 31, 2015
(86) PCT No.: PCT/JP2015/060049

§ 371 Date: Sep. 30, 2016

(30) Foreign Application Priority Data
Mar. 31, 2014 (JP) 2014-073659

(51) Int. Cl. C09J 7/02; G02F 1/1335; B32B 7/12; C08J 7/04; C09J 133/08

(52) U.S. Cl. CPC C09J 7/0246; C09J 7/0285; C08J 7/047; C09J 133/08; B32B 7/12; G02F 1/133528; C09J 2203/318; C09J 2433/00; C09J 2467/006; C08J 2333/08; B32B 2255/26; B32B 2307/42; B32B 2457/202; G02F 2202/28; G02F 2001/133302

(57) ABSTRACT

A pressure-sensitive adhesive composition comprising: a (meth)acryl-based polymer comprising (a1) 70% by weight or more of a monomer unit derived from an alkyl (meth)acrylate, (a2) 3 to 25% by weight of a monomer unit derived from an aromatic ring-containing (meth)acrylate, (a3) 0.1 to 8% by weight of a monomer unit derived from an amide group-containing monomer, (a4) 0.01 to 2% by weight of a monomer unit derived from a carboxyl group-containing monomer, and (a5) 0.01 to 3% by weight of a monomer unit derived from a hydroxyl group-containing monomer, the (meth)acryl-based polymer having a weight average molecular weight (Mw) of 1,000,000 to 2,500,000 and a weight average molecular weight (Mw)/number average molecular weight (Mn) ratio of 1.8 to 10; and a crosslinking agent, the pressure-sensitive adhesive composition containing 0.01 to 3 parts by weight of the crosslinking agent based on 100 parts by weight of the (meth)acryl-based polymer.

### TECHNICAL FIELD

The invention relates to a pressure-sensitive adhesive composition for optical films and to a pressure-sensitive adhesive layer attached optical film including an optical film and a pressure-sensitive adhesive layer formed from the pressure-sensitive adhesive composition on at least one surface of the optical film. The invention also relates to an image display device, such as a liquid crystal display device, an organic electroluminescent (EL) display device, or a plasma display panel (PDP), having the pressure-sensitive adhesive layer attached optical film. The optical film may be a polarizing film, a retardation film, an optical compensation film, a brightness enhancement film, or any laminate thereof.

### BACKGROUND ART

The image-forming system of liquid crystal displays or the like requires polarizing elements to be placed on both sides of a liquid crystal cell, and generally polarizing films are bonded thereto. In addition to polarizing films, various optical elements for improving the display quality of displays have come into use in liquid crystal panels. Examples used include retardation films for preventing discoloration, viewing angle expansion films for improving the viewing angle of liquid crystal displays, and brightness enhancement films for improving the contrast of displays. These films are collectively called optical films.

In general, a pressure-sensitive adhesive is used to bond an optical member such as the optical film to a liquid crystal cell. In order to reduce optical losses, the optical film and a liquid crystal cell or the optical films are generally bonded together with a pressure-sensitive adhesive. In such a case, the pressure-sensitive adhesive is provided in advance as a pressure-sensitive adhesive layer on one side of the optical film, and the resulting pressure-sensitive adhesive layer attached optical film is generally used because it has some advantages such as no need for a drying process to fix the optical film. In general, a release film is attached to the pressure-sensitive adhesive layer of the pressure-sensitive adhesive layer attached optical film.

The pressure-sensitive adhesive layer is required to have the property of being durable when the pressure-sensitive adhesive layer attached optical film is bonded to the glass substrate of a liquid crystal panel. For example, the pressure-sensitive adhesive layer is required not to cause defects such as peeling and lifting in endurance tests, which are usually performed as accelerated environmental tests under heating and humidifying conditions or other conditions.

Optical films (e.g., polarizing plates) tend to shrink upon heating. As a polarizing plate shrinks, the base polymer in the pressure-sensitive adhesive layer becomes oriented to produce a retardation, which can cause the problem of light leakage-induced display unevenness. Therefore, the pressure-sensitive adhesive layer is required to suppress display unevenness.

Various pressure-sensitive adhesive compositions are proposed for forming the pressure-sensitive adhesive layer of the pressure-sensitive adhesive layer attached optical film (for example, Patent Documents 1 to 3).

On the other hand, a process of manufacturing a liquid crystal display device includes peeling off a release film from the pressure-sensitive adhesive layer attached polarizing film and then bonding the pressure-sensitive adhesive layer attached polarizing film to a liquid crystal cell. In this process, static electricity is generated by peeling off the release film. The static electricity generated in this manner may affect the orientation of the liquid crystal in the liquid crystal display device to cause a failure. The static electricity may also cause display unevenness when the liquid crystal display device operates. For example, the generation of static electricity can be suppressed, for example, by forming an antistatic layer on the outer surface of the polarizing film. In order to suppress the static electricity generation in a fundamental position, however, it is effective to imparting an antistatic function to the pressure-sensitive adhesive layer.

For example, a proposed method for imparting an antistatic function to the pressure-sensitive adhesive layer includes adding an ionic compound to a pressure-sensitive adhesive used to form the pressure-sensitive adhesive layer (Patent Documents 4 and 5). Patent Document 4 discloses that an ionic solid containing an imidazolium cation and an inorganic anion is added to an acrylic pressure-sensitive adhesive for use on a polarizing film. Patent Document 5 discloses that an organic molten salt capable of being liquid at room temperature, such as an onium salt including a quaternary nitrogen atom-containing cation of 6 to 50 carbon atoms and a fluorine atom-containing anion, is added to an acrylic pressure-sensitive adhesive for use on a polarizing film.

### PRIOR ART DOCUMENTS

### Patent Documents

Patent Document 1: JP-A-2012-158702

Patent Document 2: JP-A-2009-215528

Patent Document 3: JP-A-2009-242767

Patent Document 4: JP-A-2009-251281

Patent Document 5: WO 2007/034533 A

### SUMMARY OF THE INVENTION

### Problems to be Solved by the Invention

Static electricity may cause display unevenness during the operation of liquid crystal display devices. To address this problem, a transparent conductive layer (such as a tin oxide-doped indium oxide layer or an ITO layer) is sometimes formed on the glass substrate of a liquid crystal panel. When such a liquid crystal display device is used for a touch panel, the transparent conductive layer as a measure against static electricity-induced display unevenness also functions as a shield electrode for insulating the touch panel from the driving electric field in the liquid crystal cell. In the liquid crystal display device with such features, the pressure-sensitive adhesive layer of a pressure-sensitive adhesive layer attached optical film is bonded directly to the ITO layer. Therefore, the pressure-sensitive adhesive layer is required to have good tackiness not only to a glass substrate but also to an ITO layer. In general, the pressure-sensitive adhesive layer has lower tackiness to an ITO layer than to a glass substrate, which can often cause a durability problem. It has been found that when the pressure-sensitive adhesive layer attached optical film bonded to a glass substrate is placed under high-temperature, high-humidity conditions, such as 60° C. and 95% RH, and then returned to room temperature, a phenomenon occurs in which the pressure-sensitive adhesive layer becomes clouded (humidification-induced cloudiness). The occurrence of humidification-induced cloudiness causes a reduction in display visibility.

In addition, the pressure-sensitive adhesive layer is in direct contact with an ITO layer or a metal part, such as extended copper wiring, in a liquid crystal panel. Therefore, the pressure-sensitive adhesive layer may cause the corrosion of the ITO layer or the metal part, depending on its composition. If the corrosion occurs, the problem of an increase in the resistance of the ITO layer or the extended wiring will occur.

Patent Document 1 proposes a pressure-sensitive adhesive composition containing: 100 parts by weight of an acryl-based polymer including an aromatic ring-containing monomer and an amide group-containing monomer; and 4 to 20 parts by weight of an isocyanate crosslinking agent. Unfortunately, the pressure-sensitive adhesive according to Patent Document 1 tends to easily become clouded and thus is not preferred because the monomers used to form the acryl-based polymer do not include any hydroxyl group-containing monomer so that the acryl-based polymer and the isocyanate crosslinking agent cannot react directly with each other and can undergo phase separation. In addition, the pressure-sensitive adhesive composition according to Patent Document 1 has a high crosslinking agent content and thus tends to easily cause delamination in a durability test.

Patent Documents 2 and 3 propose a pressure-sensitive adhesive composition: including a (meth)acryl-based polymer including an aromatic ring-containing (meth)acrylate and an amino group-containing (meth)acrylate; and a crosslinking agent. Unfortunately, the pressure-sensitive adhesive layer made from the pressure-sensitive adhesive composition according to Patent Documents 2 and 3 has low tackiness to an ITO layer and cannot have a satisfactory level of durability. In Patent Document 2, the comparative examples show the use of an amide group-containing monomer instead of the amino group-containing (meth)acrylate. However, the results in Table 2 of each of Patent Documents 2 and 3 show that a satisfactory level of durability is not achieved when the amide group-containing monomer is used.

On the other hand, as described in Patent Documents 4 and 5, adding an ionic compound allows a pressure-sensitive adhesive for forming a pressure-sensitive adhesive layer to have an antistatic function. In addition, since liquid crystal display devices are supposed to be used in environments at various temperatures and humidities, there has been a demand for pressure-sensitive adhesives that do not change in surface resistance even with changes in temperature or humidity and can provide a stable antistatic function over a long period of time. In recent years, there have been an increasing number of touch panel-integrated liquid crystal display devices and what are called on-cell touch panel type liquid crystal display devices, in which a sensor electrode such as an ITO layer is deposited directly on the glass substrate of a liquid crystal panel. It has been found that in these devices, a pressure-sensitive adhesive layer with too low a surface resistance can cause the problem of a reduction in touch panel sensitivity. In order to prevent both static electricity-induced unevenness and a reduction in touch panel sensitivity, it is necessary to control the surface resistance in a range narrower than the conventional range, which means that a more stable antistatic function is required than ever before.

Patent Document 4 proposes that an acrylic pressure-sensitive adhesive containing an imidazolium cation, an inorganic anion, and an ionic solid should be used to form a pressure-sensitive adhesive layer for providing a stable antistatic function over a long period of time. Unfortunately, the pressure-sensitive adhesive layer according to Patent Document 4 has insufficient tackiness to an ITO layer under humid conditions. Patent Document 5 proposes an acrylic pressure-sensitive adhesive containing an organic molten salt capable of being liquid at room temperature. Unfortunately, in the acrylic pressure-sensitive adhesive described in Patent Document 5, the organic molten salt has poor dispersibility, so that the pressure-sensitive adhesive layer made from the pressure-sensitive adhesive does not have a sufficiently stable antistatic function.

It is an object of the invention to provide a pressure-sensitive adhesive composition that is for optical films, has such a satisfactory level of durability that it does not cause foaming, peeling, or humidification-induced cloudiness when applied to both glass and a transparent conductive layer, can suppress light leakage-induced display unevenness, and can also form a pressure-sensitive adhesive layer superior in anti-metal-corrosion properties.

It is another object of the invention to provide a pressure-sensitive adhesive composition that is for optical films, has such a satisfactory level of durability that it does not cause foaming, peeling, or humidification-induced cloudiness when applied to both glass and a transparent conductive layer, can suppress light leakage-induced display unevenness, and can form a pressure-sensitive adhesive layer being superior in anti-metal-corrosion properties and capable of providing a stable antistatic function.

It is another object of the invention to provide a pressure-sensitive adhesive layer attached optical film having a pressure-sensitive adhesive layer made from such a pressure-sensitive adhesive composition for optical films, and to provide an image display device having such a pressure-sensitive adhesive layer attached optical film.

### Means for Solving the Problems

As a result of intensive studies to solve the above problems, the inventors have found the pressure-sensitive adhesive composition described below for optical films, and thus have accomplished the invention.

Specifically, the invention is directed to a pressure-sensitive adhesive composition for an optical film, the pressure-sensitive adhesive composition including:

(A) a (meth)acryl-based polymer including (a1) 70% by weight or more of a monomer unit derived from an alkyl (meth)acrylate, (a2) 3 to 25% by weight of a monomer unit derived from an aromatic ring-containing (meth)acrylate, (a3) 0.1 to 8% by weight of a monomer unit derived from an amide group-containing monomer, (a4) 0.01 to 2% by weight of a monomer unit derived from a carboxyl group-containing monomer, and (a5) 0.01 to 3% by weight of a monomer unit derived from a hydroxyl group-containing monomer, the (meth)acryl-based polymer (A) having a weight average molecular weight (Mw) of 1,000,000 to 2,500,000 and a weight average molecular weight (Mw)/number average molecular weight (Mn) ratio of 1.8 to 10; and

(B) a crosslinking agent,

the pressure-sensitive adhesive composition containing 0.01 to 3 parts by weight of the crosslinking agent (B) based on 100 parts by weight of the (meth)acryl-based polymer (A).

In the pressure-sensitive adhesive composition for an optical film, the amide group-containing monomer (a3) is preferably an N-vinyl group-containing lactam monomer.

In the pressure-sensitive adhesive composition for an optical film, the hydroxyl group-containing monomer (a5) is preferably 4-hydroxybutyl (meth)acrylate.

The crosslinking agent (B) preferably includes at least one selected from an isocyanate compound and a peroxide. The isocyanate compound preferably includes an aliphatic polyisocyanate compound.

The pressure-sensitive adhesive composition for an optical film may further contain (C) a silane coupling agent. The silane coupling agent (C) preferably has two or more alkoxysilyl groups in the molecule. The silane coupling agent (C) also preferably has an epoxy group in the molecule. The pressure-sensitive adhesive composition preferably contains 0.001 to 5 parts by weight of the silane coupling agent (C) based on 100 parts by weight of the (meth)acryl-based polymer (A).

The pressure-sensitive adhesive composition for an optical film may further contain (D) an ionic compound. The ionic compound (D) is preferably an alkali metal salt and/or an organic cation-anion salt. The ionic compound (D) preferably contains a fluoro group-containing anion. The pressure-sensitive adhesive composition preferably contains 0.05 to 10 parts by weight of the ionic compound (D) based on 100 parts by weight of the (meth)acryl-based polymer (A).

The pressure-sensitive adhesive composition for an optical film may further contain (E) a reactive silyl group-containing polyether compound. The pressure-sensitive adhesive composition preferably contains 0.001 to 10 parts by weight of the reactive silyl group-containing polyether compound (E) based on 100 parts by weight of the (meth)acryl-based polymer (A).

The invention is also directed to a pressure-sensitive adhesive layer for an optical film, the pressure-sensitive adhesive layer including a product made from the pressure-sensitive adhesive composition for an optical film.

The invention is also directed to a pressure-sensitive adhesive layer attached optical film including: an optical film; and the pressure-sensitive adhesive layer formed on at least one side of the optical film.

The invention is also directed to an image display device having at least one piece of the pressure-sensitive adhesive layer attached optical film.

### Effect of the Invention

The pressure-sensitive adhesive composition for an optical film of the invention contains, as a base polymer, the (meth)acryl-based polymer (A) having specific contents of monomer units derived from the aromatic ring-containing (meth)acrylate (a2), the amide group-containing monomer (a3), the carboxyl group-containing monomer (a4), and the hydroxyl group-containing monomer (a5) and having a specific weight average molecular weight and a specific molecular weight distribution. The pressure-sensitive adhesive layer attached optical film having the pressure-sensitive adhesive layer made from the pressure-sensitive adhesive composition for an optical film containing the (meth)acryl-based polymer (A) with the specified composition and a specific amount of the crosslinking agent (B) has such good durability that it does not cause humidification-induced cloudiness when placed on both glass and a transparent conductive layer (such as an ITO layer), and also resists peeling, lifting, or other defects when bonded to a liquid crystal cell or other devices.

In general, the durability of a pressure-sensitive adhesive layer on a transparent conductive layer such as an ITO layer is highly influenced by the composition of the ITO layer, and tends to be lower when it is on an amorphous ITO layer with a low tin content than when it is on a crystalline ITO layer with a high tin content. In this regard, the pressure-sensitive adhesive layer made from the pressure-sensitive adhesive composition for an optical film has stable durability also when placed on an amorphous ITO layer. The pressure-sensitive adhesive layer attached optical film having the pressure-sensitive adhesive layer according to the invention is also superior in anti-metal-corrosion properties when placed on a transparent conductive layer.

If an image display device, such as a liquid crystal display device, having a pressure-sensitive adhesive layer attached optical film such as a pressure-sensitive adhesive layer attached polarizing plate is exposed to heat or humid conditions, white spot-induced display unevenness such as peripheral unevenness or corner unevenness may occur at a peripheral part of a liquid crystal panel or the like, so that display defects may occur. However, the pressure-sensitive adhesive layer of the pressure-sensitive adhesive optical film according to the invention, which is made using the above pressure-sensitive adhesive composition for an optical film, makes it possible to suppress light leakage-induced display unevenness at the peripheral part of the display screen.

The pressure-sensitive adhesive composition for an optical film of the invention can have an antistatic function when containing the ionic compound (D). When containing the ionic compound (D), the pressure-sensitive adhesive composition for an optical film of the invention, which includes the (meth)acryl-based polymer (A) with the specified composition and a specific amount of the crosslinking agent (B), can form a pressure-sensitive adhesive layer having a stable antistatic function. The pressure-sensitive adhesive composition for an optical film of the invention also has good reworkability. The addition of the reactive silyl group-containing polyether compound (E) can further improve such reworkability.

### MODE FOR CARRYING OUT THE INVENTION

The pressure-sensitive adhesive composition for an optical film of the invention contains a (meth)acryl-based polymer (A) as a base polymer. The (meth)acryl-based polymer (A) includes an alkyl (meth)acrylate monomer unit as a main component. The term “(meth)acrylate” refers to acrylate and/or methacrylate, and “(meth)” is used in the same meaning in the description.

The alkyl (meth)acrylate used to form the main skeleton of the (meth)acrylic polymer (A) may have a straight- or branched-chain alkyl group of 1 to 18 carbon atoms. Examples of such an alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These may be used singly or in any combination. The average number of carbon atoms in the alkyl group is preferably from 3 to 9.

An aromatic ring-containing (meth)acrylate (a2) is used to form the (meth)acryl-based polymer (A). The aromatic ring-containing (meth)acrylate (a2) is a compound having an aromatic ring structure in its structure and also having a (meth)acryloyl group. The aromatic ring may be a benzene ring, a naphthalene ring, or a biphenyl ring. The aromatic ring-containing (meth)acrylate (a2) can provide a satisfactory level of durability (particularly, durability against transparent conductive layers) and suppress display unevenness caused by peripheral white spots.

Examples of the aromatic ring-containing (meth)acrylate (a2) include benzyl (meth)acrylate, phenyl (meth)acrylate, o-phenylphenol (meth)acrylate, phenoxy(meth)acrylate, phenoxyethyl (meth)acrylate, phenoxypropyl (meth)acrylate, phenoxydiethylene glycol (meth)acrylate, ethylene oxide-modified nonylphenol (meth)acrylate, ethylene oxide-modified cresol (meth)acrylate, phenol ethylene oxide-modified (meth)acrylate, 2-hydroxy-3-phenoxypropyl (meth)acrylate, methoxybenzyl (meth)acrylate, chlorobenzyl (meth)acrylate, cresyl (meth)acrylate, polystyryl (meth)acrylate, and other benzene ring-containing (meth)acrylates; hydroxyethylated β-naphthol acrylate, 2-naphthoethyl (meth)acrylate, 2-naphthoxyethyl acrylate, 2-(4-methoxy-1-naphthoxy)ethyl (meth)acrylate, and other naphthalene ring-containing (meth)acrylates; and biphenyl (meth)acrylate and other biphenyl ring-containing (meth)acrylates.

In view of adhesive properties and durability, the aromatic ring-containing (meth)acrylate (a2) is preferably benzyl (meth)acrylate or phenoxyethyl (meth)acrylate, more preferably phenoxyethyl (meth)acrylate.

The amide group-containing monomer (a3) is a compound having an amide group in its structure and also having a polymerizable unsaturated double bond such as that in a (meth)acryloyl group or a vinyl group. Examples of the amide group-containing monomer (a3) include acrylamide monomers such as (meth)acrylamide, N,N-dimethyl(meth)acrylamide, N,N-diethyl(meth)acrylamide, N-isopropylacrylamide, N-methyl(meth)acrylamide, N-butyl(meth)acrylamide, N-hexyl(meth)acrylamide, N-methylol(meth)acrylamide, N-methylol-N-propane(meth)acrylamide, aminomethyl(meth)acrylamide, aminoethyl(meth)acrylamide, mercaptomethyl(meth)acrylamide, and mercaptoethyl(meth)acrylamide; N-acryloyl heterocyclic monomers such as N-(meth)acryloylmorpholine, N-(meth)acryloylpiperidine, and N-(meth)acryloylpyrrolidine; and N-vinyl group-containing lactam monomers such as N-vinylpyrrolidone and N-vinyl-ε-caprolactam. The amide group-containing monomer (a3) is preferred to achieve a satisfactory level of durability. In particular, for a satisfactory level of durability against transparent conductive layers, the amide group-containing monomer (a3) is preferably an N-vinyl group-containing lactam monomer.

The carboxyl group-containing monomer (a4) is a compound having a carboxyl group in its structure and also having a polymerizable unsaturated double bond such as that in a (meth)acryloyl group or a vinyl group. Examples of the carboxyl group-containing monomer (a4) include (meth)acrylic acid, carboxyethyl (meth)acrylate, carboxypentyl (meth)acrylate, itaconic acid, maleic acid, fumaric acid, and crotonic acid. In particular, the carboxyl group-containing monomer (a4) is preferably acrylic acid in view of copolymerizability, costs, and adhesive properties.

The hydroxyl group-containing monomer (a5) is a compound having a hydroxyl group in its structure and also having a polymerizable unsaturated double bond such as that in a (meth)acryloyl group or a vinyl group. Examples of the hydroxyl group-containing monomer (a5) include hydroxyalkyl (meth)acrylates such as 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate, and (4-hydroxymethylcyclohexyl)methyl acrylate. Particularly, in view of durability, the hydroxyl group-containing monomer (a5) is preferably 2-hydroxyethyl (meth)acrylate or 4-hydroxybutyl (meth)acrylate, more preferably 4-hydroxybutyl (meth)acrylate.

When the pressure-sensitive adhesive composition contains a crosslinking agent, these copolymerizable monomers can provide reactive sites to the crosslinking agent. The carboxyl group-containing monomer (a4) and the hydroxyl group-containing monomer (a5), which are highly reactive with intermolecular crosslinking agents, are preferably used to improve the cohesiveness or heat resistance of the resulting pressure-sensitive adhesive layer. The carboxyl group-containing monomer (a4) is advantageous in improving both durability and reworkability, and the hydroxyl group-containing monomer (a5) is advantageous in improving reworkability.

The (meth)acryl-based polymer (A) contains each monomer unit at a certain content corresponding to the weight content of each monomer in all constituent monomers (100% by weight). The weight content of the alkyl (meth)acrylate (a1) may be determined as the content of the remainder other than the non-alkyl (meth)acrylate (a1) monomers, which is typically 70% by weight or more. The weight content of the alkyl (meth)acrylate (a1) may be controlled to fall within the range of 70 to 96.88% by weight. The weight content of the alkyl (meth)acrylate (a1) is preferably set in this range in order to produce reliable adhesion.

The weight content of the aromatic ring-containing (meth)acrylate (a2) is from 3 to 25% by weight, preferably from 8 to 22% by weight, more preferably from 12 to 18% by weight. A weight content of the aromatic ring-containing (meth)acrylate (a2) of less than 3% by weight can make it impossible to sufficiently suppress display unevenness. A weight content of the aromatic ring-containing (meth)acrylate (a2) of more than 25% by weight can rather cause insufficient suppression of display unevenness and also reduce durability.

The weight content of the amide group-containing monomer (a3) is from 0.1 to 8% by weight, preferably from 0.3 to 5% by weight, more preferably from 0.3 to 4% by weight, even more preferably from 0.7 to 2.5% by weight. A weight content of the amide group-containing monomer (a3) of less than 1% by weight can make it impossible to achieve a satisfactory level of durability particularly against transparent conductive layers. On the other hand, a weight content of the amide group-containing monomer (a3) of more than 8% by weight can reduce durability, and such a content is also not preferred in terms of reworkability.

The weight content of the carboxyl group-containing monomer (a4) is from 0.01 to 2% by weight, preferably from 0.05 to 1.5% by weight, more preferably from 0.1 to 1% by weight, most preferably from 0.1 to 0.5% by weight. A weight content of the carboxyl group-containing monomer (a4) of less than 0.01% by weight can make it impossible to achieve a satisfactory level of durability. On the other hand, a weight content of the carboxyl group-containing monomer (a4) of more than 2% by weight can make it impossible to achieve a satisfactory level of anti-metal-corrosion properties, and such a content is also not preferred in terms of reworkability.

The weight content of the hydroxyl group-containing monomer (a5) is from 0.01 to 3% by weight, preferably from 0.1 to 2% by weight, more preferably from 0.2 to 2% by weight. A weight content of the hydroxyl group-containing monomer (a5) of less than 0.01% by weight can cause the pressure-sensitive adhesive layer to be insufficiently crosslinked and make it impossible to achieve a satisfactory level of durability and adhesive properties. On the other hand, a weight content of the hydroxyl group-containing monomer (a5) of more than 3% by weight can make it impossible to achieve a satisfactory level of durability.

The (meth)acryl-based polymer (A) does not need to contain any other monomer unit than the monomer units described above. In order to improve adhesion and heat resistance, however, one or more additional copolymerizable monomers having an unsaturated double bond-containing polymerizable functional group, such as a (meth)acryloyl group or a vinyl group, may be introduced into the polymer (A) through the copolymerization.

Examples of such copolymerizable monomers include acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl (meth)acrylate; and phosphate group-containing monomers such as 2-hydroxyethylacryloyl phosphate.

Examples of such monomers for modification also include alkylaminoalkyl (meth)acrylates such as aminoethyl (meth)acrylate, N,N-dimethylaminoethyl (meth)acrylate, and tert-butylaminoethyl (meth)acrylate; alkoxyalkyl (meth)acrylates such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide.

Examples of modifying monomers that may also be used include vinyl monomers such as vinyl acetate and vinyl propionate; cyanoacrylate monomers such as acrylonitrile and methacrylonitrile; epoxy group-containing (meth)acrylates such as glycidyl (meth)acrylate; glycol (meth)acrylates such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as tetrahydrofurfuryl (meth)acrylate, fluoro(meth)acrylate, silicone (meth)acrylate, and 2-methoxyethyl acrylate. Examples also include isoprene, butadiene, isobutylene, and vinyl ether.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

The content of the copolymerizable monomer is preferably 0 to about 10%, more preferably 0 to about 7%, even more preferably 0 to about 5%, based on the total weight (100% by weight) of all the monomers used to form the (meth)acryl-based polymer (A).

In the invention, the (meth)acryl-based polymer (A) to be used generally has a weight average molecular weight of 1,000,000 to 2,500,000. In view of durability, particularly heat resistance, its weight average molecular weight is preferably from 1,200,000 to 2,000,000. A weight average molecular weight of less than 1,000,000 is not preferred in terms of heat resistance. As its weight average molecular weight increases to more than 2,500,000, the pressure-sensitive adhesive tends to easily become hard and becomes more likely to peel off. The polymer (A) preferably has a weight average molecular weight (Mw)/number average molecular weight (Mn) ratio of 1.8 to 10, more preferably 1.8 to 7, even more preferably 1.8 to 5, which indicates the molecular weight distribution. A molecular weight distribution (Mw/Mn) of more than 10 is not preferred in terms of durability. In this regard, the weight average molecular weight and the molecular weight distribution (Mw/Mn) are the values calculated from polystyrene equivalent values determined by gel permeation chromatography (GPC).

For the production of the (meth)acrylic polymer (A), any appropriate method may be selected from known production methods such as solution polymerization, bulk polymerization, emulsion polymerization, and various radical polymerization methods. The resulting (meth)acrylic polymer (A) may be any type of copolymer such as a random copolymer, a block copolymer and a graft copolymer.

In a solution polymerization process, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acrylic polymer (A) may be controlled by the reaction conditions including the amount of addition of the polymerization initiator or the chain transfer agent and reaction condition. The amount of the addition may be controlled as appropriate depending on the type of these materials.

Examples of the polymerization initiator include, but are not limited to, azo initiators such as 2,2′-azobisisobutylonitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total amount of the polymerization initiator is preferably from about 0.005 to 1 part by weight, more preferably from about 0.02 to about 0.5 parts by weight, based on 100 parts by weight of the monomer.

For example, when 2,2′-azobisisobutyronitrile is used as a polymerization initiator for the production of the (meth)acrylic polymer with the above weight average molecular weight, the polymerization initiator is preferably used in an amount of from about 0.06 to 0.2 parts by weight, more preferably of from about 0.08 to 0.175 parts by weight, based on 100 parts by weight of the total amount of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One of these chain transfer agents may be used alone, or two or more thereof may be used in a mixture. The total amount of the chain transfer agent is preferably 0.1 parts by weight or less, based on 100 parts by weight of the total amount of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE10N (manufactured by Asahi Denka Kogyo K.K.). The reactive emulsifier is preferred, because after polymerization, it can be incorporated into a polymer chain to improve water resistance. Based on 100 parts by weight of the total monomer component, the emulsifier is preferably used in an amount of 0.3 to 5 parts by weight, more preferably of 0.5 to 1 parts by weight, in view of polymerization stability or mechanical stability.

The pressure-sensitive adhesive composition of the invention contains (B) a crosslinking agent. The crosslinking agent (B) may be an organic crosslinking agent or a polyfunctional metal chelate. An organic crosslinking agent or a polyfunctional metal chelate may also be used as the crosslinking agent (B). Examples of the organic crosslinking agent include an isocyanate crosslinking agent, an epoxy crosslinking agent, a peroxide crosslinking agent and an imine crosslinking agents. The polyfunctional metal chelate may include a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The crosslinking agent (B) is preferably an isocyanate crosslinking agent and/or a peroxide crosslinking agent.

The isocyanate crosslinking agent (B) may be a compound having at least two isocyanate groups. For example, an aliphatic polyisocyanate, an alicyclic polyisocyanate, or an aromatic polyisocyanate known in the art and commonly used for urethane-forming reaction may be used as the isocyanate crosslinking agent (B).

Examples of the aliphatic polyisocyanate include trimethylene diisocyanate, tetramethylene diisocyanate, hexamethylene diisocyanate, pentamethylene diisocyanate, 1,2-propylene diisocyanate, 1,3-butylene diisocyanate, dodecamethylene diisocyanate, and 2,4,4-trimethylhexamethylene diisocyanate.

Examples of the alicyclic isocyanate include 1, 3-cyclopentene diisocyanate, 1,3-cyclohexane diisocyanate, 1,4-cyclohexane diisocyanate, isophorone diisocyanate, hydrogenated diphenylmethane diisocyanate, hydrogenated xylylene diisocyanate, hydrogenated tolylene diisocyanate, and hydrogenated tetramethylxylylene diisocyanate.

Examples of the aromatic diisocyanate include phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyl diisocyanate, 1,5-naphthalene diisocyanate, and xylylene diisocyanate.

Examples of the isocyanate crosslinking agent (B) also include multimers (such as dimers, trimers, or pentamers) of these diisocyanates, urethane diisocyanates produced by reaction of diisocyanates with a polyalcohol such as trimethylolpropane, urea diisocyanates, biuret diisocyanates, allophanate diisocyanates, isocyanurate diisocyanates, and carbodiimide diisocyanates.

Commercially available examples of the isocyanate crosslinking agent (B) include MILLIONATE MT, MILLIONATE MTL, MILLIONATE MR-200, MILLIONATE MR-400, CORONATE L, CORONATE HL, and CORONATE HX (all trade names, manufactured by NIPPON POLYURETHANE INDUSTRY CO., LTD.), and TAKENATE D-110N, TAKENATE D-120N, TAKENATE D-140N, TAKENATE D-160N, TAKENATE D-165N, TAKENATE D-170HN, TAKENATE D-178N, TAKENATE 500, and TAKENATE 600 (all trade names, manufactured by Mitsui Chemicals, Inc.). These compounds may be used alone or in combination of two or more.

Preferred examples of the isocyanate crosslinking agent (B) include aliphatic polyisocyanates and aliphatic polyisocyanate compounds, which are derivatives of aliphatic polyisocyanates. Aliphatic polyisocyanate compounds can form a crosslinked structure more flexible than that obtained with other isocyanate crosslinking agents, can easily relax the stress associated with the expansion or shrinkage of optical films, and are less likely to cause peeling in a durability test. In particular, preferred aliphatic polyisocyanate compounds include hexamethylene diisocyanate and derivatives thereof.

Any peroxide capable of generating active radical species by heating or photoirradiation and promoting the crosslinking of the base polymer in the pressure-sensitive adhesive composition may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

The content of the crosslinking agent (B) is preferably from 0.01 to 3 parts by weight, more preferably from 0.02 to 2 parts by weight, even more preferably from 0.03 to 1 part by weight, based on 100 parts by weight of the (meth)acryl-based polymer (A). A crosslinking agent (B) content of less than 0.01 parts by weight can cause the pressure-sensitive adhesive layer to be crosslinked insufficiently so that a satisfactory level of durability or adhesive properties may fail to be achieved. On the other hand, a crosslinking agent (B) content of more than 3 parts by weight can make the pressure-sensitive adhesive layer too hard so that a tendency to reduce its durability can be observed.

The above isocyanate crosslinking agents may be used singly or in combination of two or more. The total content of the isocyanate crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acryl-based polymer (A). The crosslinking agent (B) may be added in an appropriate amount in view of cohesive strength, resistance to peeling in a durability test, and other properties.

One of the peroxide crosslinking agents may be used alone, or a mixture of two or more of the peroxide crosslinking agent may be used. The total amount of the peroxide(s) is preferably from 0.01 to 2 parts by weight, more preferably from 0.04 to 1.5 parts by weight, even more preferably from 0.05 to 1 part by weight, based on 100 parts by weight of the (meth)acrylic polymer (A). The amount of the peroxide (s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

The pressure-sensitive adhesive composition of the invention may further contain a silane coupling agent (C). The durability or the reworkability can be improved using the silane coupling agent (C). Examples of silane coupling agent include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane. Epoxy group-containing silane coupling agents are preferred among the silane coupling agents listed above.

The silane coupling agent (C) may also be one having two or more alkoxysilyl groups in the molecule. Examples thereof include X-41-1053, X-41-1059A, X-41-1056, X-41-1805, X-41-1818, X-41-1810, and X-40-2651 manufactured by Shin-Etsu Chemical Co., Ltd. These silane coupling agents having two or more alkoxysilyl groups in the molecule are preferable in that they are less volatile and effective in improving durability due to their two or more alkoxysilyl groups. In particular, these silane coupling agents can provide suitable durability also when the adherend on the pressure-sensitive adhesive layer attached optical film is a transparent conductive layer (such as an ITO layer), which is less reactive with the alkoxysilyl group than glass. The silane coupling agent having two or more alkoxysilyl groups in the molecule is preferably one having an epoxy group in the molecule, more preferably one having two or more epoxy groups in the molecule. The silane coupling agent having two or more alkoxysilyl groups and an epoxy group(s) in the molecule tends to provide good durability also when the adherend is a transparent conductive layer (such as an ITO layer). Examples of the silane coupling agent having two or more alkoxysilyl groups and an epoxy group(s) in the molecule include X-41-1053, X-41-1059A, and X-41-1056 manufactured by Shin-Etsu Chemical Co., Ltd, among which X-41-1056 manufactured by Shin-Etsu Chemical Co., Ltd. is particularly preferred, which has a high epoxy group content.

One of the silane coupling agents (C) may be used alone, or a mixture of two or more of the silane coupling agents. The total amount of the silane coupling agent(s) is preferably from 0.001 to 5 parts by weight, more preferably from 0.01 to 1 part by weight, even more preferably from 0.02 to 1 part by weight, still more preferably from 0.05 to 0.6 parts by weight, based on 100 parts by weight of the (meth)acrylic polymer (A). The content should be such as to improve durability and maintain a suitable level of adhering strength to glass and transparent conductive layers.

The pressure-sensitive adhesive composition of the invention may contain (D) an ionic compound. An alkali metal salt and/or an organic cation-anion salt is preferably used as the ionic compound (D). The alkali metal salt may be any of organic and inorganic salts of alkali metals. As used herein, the term “organic cation-anion salt” refers to an organic salt having an organic cation moiety, in which the anion moiety may be organic or inorganic. The “organic cation-anion salt” is also referred to as the ionic liquid or the ionic solid.

<Alkali Metal Salt>

The cation moiety of the alkali metal salt includes an alkali metal ion, which may be any of lithium, sodium, and potassium ions. Lithium ion is preferred among these alkali metal ions.

The anion moiety of the alkali metal salt may include an organic material or an inorganic material. Examples of the anion moiety that may be used to form the organic salt include CH₃COO⁻, CF₃COO⁻, CH₃SO₃⁻, CF₃SO₃⁻, (CF₃SO₂)₃C⁻′ C₄F₉SO₃⁻, C₃F₇COO⁻, (CF₃SO₂)(CF₃CO)N⁻, ⁻O₃S(CF₂)₃SO₃⁻, PF₆⁻, and CO₃²⁻, and those represented by the following general formulae (1) to (4):

(CₙF₂ₙ₊₁SO₂)₂N⁻, (1)

wherein n is an integer of 1 to 10;

CF₂(CₘF₂ₘSO₂)₂N⁻, (2)

wherein m is an integer of 1 to 10;

⁻O₃S(CF₂)ₗSO₃⁻, (3)

wherein l is an integer of 1 to 10; and

(CₚF₂ₚ₊₁SO₂)N⁻(C_{q}F_{2q+l}SO₂), (4)

wherein p and q are each an integer of 1 to 10. In particular, a fluorine atom-containing anion moiety is preferably used because it can form an ionic compound with good ionic dissociation properties. Examples of the anion moiety that may be used to form the inorganic salt include Cl⁻, Br⁻, I⁻, AlCl₄⁻, Al₂Cl₇⁻, BF₄⁻, PF₆⁻, ClO₄⁻, NO₃⁻, AsF₆⁻, SbF₆⁻, NbF₆⁻, TaF₆⁻, and (CN)₂N⁻. The anion moiety is preferably (perfluoroalkylsulfonyl)imide represented by the general formula (1), such as (CF₃SO₂)₂N⁻ or (C₂F₅SO₂)₂N⁻, in particular, preferably (trifluoromethanesulfonyl)imide such as (CF₃SO₂)₂N⁻.

Examples of organic salts of alkali metals include sodium acetate, sodium alginate, sodium lignosulfonate, sodium toluenesulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K, and LiO₃S(CF₂)₃SO₃K. Among them, LiCF₃SO₃, Li(CF₃SO₂)₂N, Li(C₂F₅SO₂)₂N, Li(C₄F₉SO₂)₂N, Li(CF₃SO₂)₃C, and the like are preferred, fluorine-containing lithium imide salts such as Li(CF₃SO₂)₂N, Li(C₂F₅SO₂)₂N, and Li(C₄F₉SO₂)₂N are more preferred, and a (perfluoroalkylsulfonyl)imide lithium salt is particularly preferred.

Examples of inorganic salts of alkali metals include lithium perchlorate and lithium iodide.

<Organic Cation-Anion Salt>

The organic cation-anion salt for use in the invention includes a cation component and an anion component, in which the cation component is organic. Examples of the cation component include a pyridinium cation, a piperidinium cation, a pyrrolidinium cation, a pyrroline skeleton-containing cation, a pyrrole skeleton-containing cation, an imidazolium cation, a tetrahydropyrimidinium cation, a dihydropyrimidinium cation, a pyrazolium cation, a pyrazolinium cation, a tetraalkylammonium cation, a trialkylsulfonium cation, and a tetraalkylphosphonium cation.

Examples of the anion component that may be used include Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂)(CF₃CO)N⁻, ⁻O₃S(CF₂)₃SO₃⁻, and anions represented by formulae (1) to (4) below.

(CₙF₂ₙ₊₁SO₂)₂N⁻, (1)

wherein n is an integer of 1 to 10.

CF₂(CₘF₂ₘSO₂)₂N⁻, (2)

wherein m is an integer of 1 to 10.

⁻O₃S(CF₂)ₗSO₃⁻, (3)

wherein l is an integer of 1 to 10.

(CₚF₂ₚ₊₁SO₂)N⁻(C_{q}F_{2q+1}SO₂), (4)

wherein p and q are each an integer of 1 to 10. In particular, fluorine atom-containing anion components are preferably used because they can form ionic compounds with high ability to dissociate ions.

Any compounds appropriately selected from combinations of any of the above cation components and any of the above anion components may be used as specific examples of the organic cation-anion salt.

Such examples include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 2-methyl-1-pyrroline tetrafluoroborate, 1-ethyl-2-phenylindole tetrafluoroborate, 1, 2-dimethylindole tetrafluoroborate, 1-ethylcarbazole tetrafluoroborate, 1-ethyl-3-methylimidazolium tetrafluoroborate, 1-ethyl-3-methylimidazolium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium perfluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl)methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, l-octyl-3-methylimidazolium tetrafluoroborate, l-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 3-methylpyrazolium tetrafluoroborate, tetrahexylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N,N-diethyl-N-methyl-N-(2-methoxyethyl)ammonium (trifluoromethanesulfonyl)trifluoroacetamide, diallydimethylammonium (trifluoromethanesulfonyl)trifluoroacetamide, glycidyltrimethylammonium (trifluoromethanesulfonyl)trifluoroacetamide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, and 1-butyl-3-methylpyridine-1-ium trifluoromethanesulfonate. Commercially available products of the above may be used, such as CIL-314 (manufactured by Japan Carlit Co., Ltd.) and ILA2-1 (manufactured by KOEI CHEMICAL COMPANY LIMITED).

Examples also include tetramethylammonium bis(trifluoromethanesulfonyl)imide, trimethylethylammonium bis(trifluoromethanesulfonyl)imide, trimethylbutylammonium bis(trifluoromethanesulfonyl)imide, trimethylpentylammonium bis(trifluoromethanesulfonyl)imide, trimethylheptylammonium bis(trifluoromethanesulfonyl)imide, trimethyloctylammonium bis(trifluoromethanesulfonyl)imide, tetraethylammonium bis(trifluoromethanesulfonyl)imide, triethylbutylammonium bis(trifluoromethanesulfonyl)imide, tetrabutylammonium bis(trifluoromethanesulfonyl)imide, and tetrahexylammonium bis(trifluoromethanesulfonyl)imide.

Examples also include 1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-heptylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1-propyl-1-butylpiperidinium bis(pentafluoroethanesulfonyl)imide, 1,1-dipropylpiperidinium bis(pentafluoroethanesulfonyl)imide, and 1,1-dibutylpiperidinium bis(pentafluoroethanesulfonyl)imide.

Examples also include derivatives of the above compounds, in which the cation component is replaced by trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, or tetrahexylphosphonium cation.

Examples also include derivatives of the above compounds, in which bis(trifluoromethanesulfonyl)imide is replaced by bis(pentafluorosulfonyl)imide, bis(heptafluoropropanesulfonyl)imide, bis(nonafluorobutanesulfonyl)imide, trifluoromethanesulfonylnonafluorobutanesulfonylimide, heptafluoropropanesulfonyltrifluoromethanesulfonylimide, pentafluoroethanesulfonylnonafluorobutanesulfonylimide, or cyclo-hexafluoropropane-1,3-bis(sulfonyl)imide anion.

Besides the alkali metal salts and the organic cation-anion salts, examples of the ionic compound (D) also include inorganic salts such as ammonium chloride, aluminum chloride, copper chloride, ferrous chloride, ferric chloride, and ammonium sulfate. These ionic compounds (D) may be used alone or in combination of two or more.

The content of the ionic compound (D) in the pressure-sensitive adhesive composition of the invention is preferably from 0.05 to 10 parts by weight based on 100 parts by weight of the (meth)acryl-based polymer (A). If the content of the ionic compound (D) is less than 0.05 parts by weight, the effect of improving antistatic performance may be insufficient in some cases. The content of the ionic compound (D) is preferably 0.1 parts by weight or more, more preferably 0.5 parts by weight or more. On the other hand, if the content of the ionic compound (D) is more than 10 parts by weight, durability may be insufficient in some cases. The content of the ionic compound (D) is preferably 5 parts by weight or less, more preferably 3 parts by weight or less, even more preferably 1 part by weight or less. The preferred range of the content of the ionic compound (D) can be determined using the above upper and lower limits.

The pressure-sensitive adhesive composition of the invention may further contain (E) a reactive silyl group-containing polyether compound. The polyether compound (E) is preferable in that it can improve reworkability. For example, the compound disclosed in JP-A-2010-275522 may be used as the polyether compound (E).

The reactive silyl group-containing polyether compound (E) may have a polyether skeleton and a reactive silyl group at at least one end, wherein the reactive silyl group is represented by formula (1): —SiRₐM₃₋ₐ, wherein R is a monovalent organic group having 1 to 20 carbon atoms and optionally having a substituent, M is a hydroxyl group or a hydrolyzable group, and a is an integer of 0 to 2. In the formula, two or more R groups, if any, may be the same or different, and two or more M groups, if any, may be the same or different.

The reactive silyl group-containing polyether compound (E) may be a compound represented by formula (2): RₐM₃₋ₐSi—X—Y-(AO)ₙ—Z, wherein R is a monovalent organic group having 1 to 20 carbon atoms and optionally having a substituent, M is a hydroxyl group or a hydrolyzable group, a is an integer of 0 to 2, two or more R groups, if any, may be the same or different, two or more M groups, if any, may be the same or different, AO is a straight- or branched-chain oxyalkylene group of 1 to 10 carbon atoms, n is the average number of moles of the added oxyalkylene group and is from 1 to 1,700, X is a straight- or branched-chain alkylene group of 1 to 20 carbon atoms, and Y is an ether bond, an ester bond, a urethane bond, or a carbonate bond.

In the formula, Z is a hydrogen atom, a monovalent hydrocarbon group of 1 to 10 carbon atoms,

a group represented by formula (2A): —Y¹—X—SiRₐM₃₋ₐ, wherein R, M, and X have the same meanings as defined above, and Y¹ is a single bond, a —CO— bond, a —CONH— bond, or a —COO— bond, or

a group represented by formula (2B): -Q{-(OA)ₙ-Y—X—SiRₐM₃₋ₐ}ₘ, wherein R, M, X, and Y have the same meanings as defined above, OA has the same meaning as AO defined above, n has the same meaning as defined above, Q is a divalent or polyvalent hydrocarbon group of 1 to 10 carbon atoms, and m is a number that is the same as the valence of the hydrocarbon group.

Examples of the reactive silyl group-containing polyether compound (E) include MS Polymers S203, S303, and S810 manufactured by Kaneka Corporation; SILYL EST250 and SILYL EST280 manufactured by Kaneka Corporation; SILYL SAT10, SILYL SAT200, SILYL SAT220, SILYL SAT350, and SILYL SAT400 manufactured by Kaneka Corporation; and EXCESTAR S2410, S2420, or S3430 manufacture by ASAHI GLASS CO., LTD.

The content of the polyether compound (E) in the pressure-sensitive adhesive composition of the invention is preferably from 0.001 to 10 parts by weight based on 100 parts by weight of the (meth)acryl-based polymer (A). If the content of the polyether compound (E) is less than 0.001 parts by weight, the effect of improving reworkability may be insufficient in some cases. The content of the polyether compound (E) is preferably 0.01 parts by weight or more, more preferably 0.1 parts by weight or more. On the other hand, a polyether compound (E) content of more than 10 parts by weight is not preferred in terms of durability. The content of the polyether compound (E) is preferably 5 parts by weight or less, more preferably 2 parts by weight or less. The preferred range of the content of the polyether compound (E) can be determined using the above upper and lower limits.

The pressure-sensitive adhesive composition of the invention may also contain any other known additive. For example, a polyether compound of a polyalkylene glycol such as polypropylene glycol, a powder such as a colorant and a pigment, a dye, a surfactant, a plasticizer, a tackifier, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range. These additives are preferably used in an amount of 5 parts by weight or less, more preferably 3 parts by weight or less, even more preferably 1 part by weight or less, based on 100 parts by weight of the (meth)acryl-based polymer (A).

The pressure-sensitive adhesive composition is used to form a pressure-sensitive adhesive layer. To form the pressure-sensitive adhesive layer, it is preferred that the total amount of the addition of the crosslinking agent should be controlled and that the effect of the crosslinking temperature and the crosslinking time should be carefully taken into account.

The crosslinking temperature and the crosslinking time may be controlled depending on the crosslinking agent used. The crosslinking temperature is preferably 170° C. or less.

The crosslinking process may be performed at the temperature of the process of drying the pressure-sensitive adhesive layer, or the crosslinking process may be separately performed after the drying process.

The crosslinking time is generally from about 0.2 to about 20 minutes, preferably from about 0.5 to about 10 minutes, while it may be set taking into account productivity and workability.

The pressure-sensitive adhesive layer attached optical member, such as the pressure-sensitive adhesive layer attached optical film, according to the invention may include an optical film and a pressure-sensitive adhesive layer formed from the pressure-sensitive adhesive composition on at least one surface of the optical film.

For example, the pressure-sensitive adhesive layer may be formed by a method including applying the pressure-sensitive adhesive composition to a release-treated separator or the like, removing the polymerization solvent and so on by drying to form a pressure-sensitive adhesive layer and then transferring it to a polarizing film, or by a method including applying the pressure-sensitive adhesive composition to a polarizing film and removing the polymerization solvent and so on by drying to form a pressure-sensitive adhesive layer on the polarizing film. Before the pressure-sensitive adhesive is applied, in addition at least one solvent other than the polymerization solvent may be added to the pressure-sensitive adhesive.

A silicone release liner is preferably used as the release-treated separator. The pressure-sensitive adhesive composition of the invention may be applied to such a liner and dried to form a pressure-sensitive adhesive layer. In this process, the pressure-sensitive adhesive may be dried using any appropriate method depending on the purpose. A method of drying by heating the coating film is preferably used. The heat drying temperature is preferably from 40° C. to 200° C., more preferably from 50° C. to 180° C., particularly preferably from 70° C. to 170° C. When the heating temperature is set in the above range, a pressure-sensitive adhesive having good adhesive properties can be obtained.

Any appropriate drying time may be used. The drying time is preferably from 5 seconds to 20 minutes, more preferably from 5 seconds to 10 minutes, particularly preferably from 10 seconds to 5 minutes.

Before the pressure-sensitive adhesive layer is formed on the surface of the optical film, an anchor layer may be formed on the surface, or any adhesion-promoting treatment such as a corona treatment or a plasma treatment may be performed on the surface. The surface of the pressure-sensitive adhesive layer may also be subjected to an adhesion-promoting treatment.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness of the pressure-sensitive adhesive layer is typically, but not limited to, from about 1 to 100 μm, preferably from 2 to 50 μm, more preferably from 2 to 40 μm, further preferably from 5 to 35 μm.

When the pressure-sensitive adhesive layer is exposed, the pressure-sensitive adhesive layer may be protected with a sheet having undergone release treatment (a separator) before practical use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

In the above production method, the release-treated sheet may be used without modification as a separator for the pressure-sensitive adhesive sheet, the pressure-sensitive adhesive layer-attached optical film or the like, so that the process can be simplified.

The optical film may be of any type suitable for forming image display devices such as liquid crystal display devices. The optical film may be, for example, a polarizing film. Typically, a polarizing film including a polarizer and a transparent protective film or films provided on one or both surfaces of the polarizer may be used.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol-based film, partially formalized polyvinyl alcohol-based film, and ethylene-vinyl acetate copolymer-based partially saponified film; poly-ene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Although thickness of polarizer is not especially limited, the thickness of about 80 μm or less is commonly adopted.

A polarizer that is uniaxially stretched after a polyvinyl alcohol-based film dyed with iodine is obtained by stretching a polyvinyl alcohol-based film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thin polarizer with a thickness of 10 μm or less may also be used. In view of thinning, the thickness is preferably from 1 to 7 μm. Such a thin polarizer is less uneven in thickness, has good visibility, and is less dimensionally-variable and therefore has high durability. It is also preferred because it can form a thinner polarizing film.

Typical examples of such a thin polarizer include the thin polarizing films disclosed in JP-A No. 51-069644, JP-A No. 2000-338329, WO2010/100917, specification of PCT/JP2010/001460, specification of Japanese Patent Application No. 2010-269002, or specification of Japanese Patent Application No. 2010-263692. These thin polarizing films can be obtained by a process including the steps of stretching a laminate of a polyvinyl alcohol-based resin (hereinafter also referred to as PVA-based resin) layer and a stretchable resin substrate and dyeing the laminate. Using this process, the PVA-based resin layer, even when thin, can be stretched without problems such as breakage, which would otherwise be caused by stretching of the layer supported on a stretchable resin substrate.

The thin polarizing film should be produced by a process capable of achieving high-ratio stretching to improve polarizing performance, among processes including the steps of stretching and dyeing a laminate. From this point of view, the thin polarizing film is preferably obtained by a process including the step of stretching in an aqueous boric acid solution as described in WO 2010/100917 A, PCT/JP2010/001460, Japanese Patent Application No. 2010-269002, or Japanese Patent Application No. 2010-263692, and more preferably obtained by a process including the step of performing auxiliary in-air stretching before stretching in an aqueous boric acid solution as described in Japanese Patent Application No. 2010-269002 or 2010-263692.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film may be bonded with an adhesive layer to one side of the polarizer. On the other side of the polarizer, a thermosetting or ultraviolet-curable resin such as a (meth)acrylic, urethane, acrylic urethane, epoxy, or silicone resin may be used to form the transparent protective film. The transparent protective film may contain any one or more suitable additives. Such additives include, for example, ultraviolet absorbers, antioxidants, lubricants, plasticizers, release agents, anti-coloring agents, flame retardants, nucleating agents, antistatic agents, pigments, and colorants. The content of the thermoplastic resin in the transparent protective film is preferably from 50 to 100% by weight, more preferably from 50 to 99% by weight, even more preferably from 60 to 98% by weight, further more preferably from 70 to 97% by weight. If the content of the thermoplastic resin in the transparent protective film is less than 50% by weight, high transparency and other properties inherent in the thermoplastic resin may be insufficiently exhibited.

The adhesive used to bond the polarizer to the transparent protective film may be any of various optically-transparent adhesives, such as water-based adhesives, solvent-based adhesives, hot melt adhesives, radical-curable adhesives, and cationically curable adhesives, among which water-based adhesives or radical-curable adhesives are preferred.

Examples of the optical film include a reflector, a transflector, a retardation film (including a wavelength plate such as a half or quarter wavelength plate), a viewing angle compensation film, a brightness enhancement film, and any other optical layer that can be used to form liquid crystal display devices or other devices. They may be used alone as the optical film, or one or more layers of any of them may be used together with the polarizing film to form a laminate for practical use.

The optical film including a laminate of the polarizing film and the optical layer may be formed by a method of stacking them one by one in the process of manufacturing a liquid crystal display device or the like. However, an optical film formed in advance by lamination is advantageous in that it can facilitate the process of manufacturing a liquid crystal display device or the like because it has stable quality and good assembling workability. In the lamination, any appropriate bonding means such as a pressure-sensitive adhesive layer may be used. When the polarizing film and any other optical layer are bonded together, their optical axes may be each aligned at an appropriate angle, depending on the desired retardation properties or other desired properties.

The pressure-sensitive adhesive layer attached optical film of the invention is preferably used to form liquid crystal display devices or other various image display devices. Liquid crystal display devices may be formed according to conventional techniques. Specifically, a liquid crystal display device may be typically formed by appropriately assembling a display panel such as a liquid crystal cell, a pressure-sensitive adhesive layer attached optical film, and an optional component such as a lighting system, and incorporating a driving circuit according to any conventional techniques, except that the pressure-sensitive adhesive layer attached optical film used is according to the invention. The liquid crystal cell to be used may also be of any type such as TN type, STN type, n type, VA type, or IPS type.

Suitable liquid crystal displays, such as liquid crystal display with which the pressure-sensitive adhesive layer-attached optical film has been located at one side or both sides of the liquid crystal cell, and with which a backlight or a reflective plate is used for a lighting system may be manufactured. In this case, the pressure-sensitive adhesive layer-attached optical film may be installed in one side or both sides of the liquid crystal cell. When installing the optical films in both sides, they may be of the same type or of different type. Furthermore, in assembling a liquid crystal display, suitable parts, such as diffusion layer, anti-glare layer, antireflection film, protective plate, prism array, lens array sheet, optical diffusion sheet, and backlight, may be installed in suitable position in one layer or two or more layers.

### EXAMPLES

The invention is more specifically described by the examples below, which are not intended to limit the scope of the invention. In each example, parts and % are all by weight. Unless otherwise stated below, the conditions of room temperature standing are 23° C. and 65% RH in all the cases.

<Measurement of Weight Average Molecular Weight of (Meth)Acryl-Based Polymer (A)>

The weight average molecular weight (Mw) of the (meth)acryl-based polymer (A) was measured by gel permeation chromatography (GPC). The Mw/Mn ratio of the polymer (A) was also determined using the same method.

Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mmφ×30 cm, 90 cm in total
Column temperature: 40° C.
Flow rate: 0.8 ml/minute
Injection volume: 100 μl
Eluent: tetrahydrofuran
Detector: differential refractometer (RI)
Standard sample: polystyrene

<Preparation of Polarizing Film>

An 80-μm-thick polyvinyl alcohol film was stretched to 3 times between rolls different in velocity ratio while it was dyed in a 0.3% iodine solution at 30° C. for 1 minute. The film was then stretched to a total stretch ratio of 6 times while it was immersed in an aqueous solution containing 4% of boric acid and 10% of potassium iodide at 60° C. for 0.5 minutes. Subsequently, the film was washed by immersion in an aqueous solution containing 1.5% of potassium iodide at 30° C. for 10 seconds and then dried at 50° C. for 4 minutes to give a 30-μm-thick polarizer. A polarizing film was formed by bonding 80-μm-thick saponified triacetylcellulose films to both sides of the polarizer with a polyvinyl alcohol-based adhesive.

### Example 1

### Preparation of Acryl-Based Polymer (A1)

A four-necked flask equipped with a stirring blade, a thermometer, a nitrogen gas inlet tube, and a condenser was charged with a monomer mixture containing 74.8 parts of butyl acrylate, 23 parts of phenoxyethyl acrylate, 1.5 parts of N-vinyl-2-pyrrolidone, 0.3 parts of acrylic acid, and 0.4 parts of 4-hydroxybutyl acrylate. The flask was further charged with 0.1 parts of 2,2′-azobisisobutyronitrile as a polymerization initiator and 100 parts of ethyl acetate, based on 100 parts (solids) of the monomer mixture. While the mixture was gently stirred, nitrogen gas was introduced to replace the air in the flask. Subsequently, the mixture was subjected to polymerization reaction for 8 hours while the liquid in the flask was maintained at around 55° C., so that a solution of an acryl-based polymer (A1) with a weight average molecular weight (Mw) of 1,600,000 and a Mw/Mn ratio of 3.7 was obtained.

(Preparation of Pressure-Sensitive Adhesive Composition)

On the basis of 100 parts of the solid in the acryl-based polymer (A1) solution obtained in Production Example 1, 0.1 parts of an isocyanate crosslinking agent (TAKENATE D160N manufactured by Mitsui Chemicals, Inc., trimethylolpropane/hexamethylene diisocyanate), 0.3 parts of benzoyl peroxide (NYPER BMT manufactured by NOF CORPORATION), and 0.2 parts of γ-glycidoxypropylmethoxysilane (KBM-403 manufactured by Shin-Etsu Chemical Co., Ltd.) were added to the acryl-based polymer (A1) solution to form an acrylic pressure-sensitive adhesive composition solution.

(Preparation of Pressure-Sensitive Adhesive Layer Attached Polarizing Film)

The acrylic pressure-sensitive adhesive composition solution was then applied to one side of a silicone release agent-treated polyethylene terephthalate film (MRF38 manufactured by Mitsubishi Plastics, Inc., separator film) so that a 23-μm-thick pressure-sensitive adhesive layer could be formed after drying. The composition solution was then dried at 155° C. for 1 minute to form a pressure-sensitive adhesive layer on the surface of the separator film. Subsequently, the pressure-sensitive adhesive layer was transferred from the separator film onto the polarizing film prepared as described above, so that a pressure-sensitive adhesive layer attached polarizing film was obtained.

### Examples 2 to 29 and Comparative Examples 1 to 13

Acryl-based polymer solutions with the polymer characteristics (weight average molecular weight and Mn/Mn) shown in Table 1 were prepared as in Example 1, except that the type and content of the monomers used to form the acryl-based polymer (A) were changed as shown in Table 1 under controlled production conditions.

Acrylic pressure-sensitive adhesive composition solutions were also prepared as in Example 1, except that for each resulting acryl-based polymer solution, the type or content of the crosslinking agent (B) and the type or content (and presence or absence) of the silane coupling agent (C) were changed as shown in Table 1. Pressure-sensitive adhesive layer attached polarizing plates were also prepared as in Example 1, except that the resulting acrylic pressure-sensitive adhesive composition solutions were used instead. In each of Examples 24 to 26 and 28 and Comparative Example 5, the ionic compound (D) was added in the amount shown in Table 1 when the acryl-based polymer solution was prepared. In Example 27, the reactive silyl group-containing polyether compound (E) was added in the amount shown in Table 1 when the acryl-based polymer solution was prepared.

The pressure-sensitive adhesive layer attached polarizing films obtained in the examples and the comparative examples were evaluated as described below. Table 2 shows the evaluation results. It should be noted that only the pressure-sensitive adhesive layer attached polarizing films obtained in Examples 24 to 26 and 28 and Comparative Example 5 were measured for surface resistance.

<Durability Test on Glass>

A 37-inch-sized piece was cut from each pressure-sensitive adhesive layer attached polarizing film and used as a sample. The sample was attached to a 0.7-mm-thick non-alkali glass sheet (EG-XG manufactured by Corning Incorporated) using a laminator. The sample was then autoclaved at 0.5 MPa and 50° C. for 15 minutes to be completely bonded to the non-acrylic glass sheet. The treated sample was visually evaluated for the appearance between the polarizing plate and the glass sheet based on the criteria below after subjected to a 500-hour treatment under the atmosphere at 80° C., 85° C., or 90° C. (heat test) (note that the 90° C. treatment was performed only on the samples of Examples 3, 23, 25, 28, and 29 and Comparative Examples 4 and 5), subjected to a 500-hour treatment under the atmosphere at 60° C. and 90% RH or at 60° C. and 95% RH (humidity test), or subjected to 300 cycles of 85° C. and −40° C. environments for 1 hour/cycle (heat shock test).

### (Evaluation Criteria)

⊙: Any change in appearance, such as foaming or peeling is not observed at all.
◯: Peeling at an end part or foaming is slightly observed, but there is no practical problem.
Δ: Peeling at an end part or foaming is observed, but there is no practical problem unless the intended use is special.
x: Peeling is significantly observed at an end part, and there is a practical problem.

<Durability Test on ITO Glass>

A crystalline or amorphous ITO layer was formed on a non-alkali glass sheet, which was the same as the adherend used in the above durability test on glass. The resulting laminate was used as an adherend in a durability test on ITO glass. The durability test was performed using the same procedure as in the durability test on glass, except that the adherend was changed to the resulting laminate and the sample was attached to the ITO layer. The ITO layer was formed by sputtering. Concerning the composition of ITO, the crystalline ITO had a Sn content of 10% by weight, and the amorphous ITO had a Sn content of 3% by weight. Each ITO layer was subjected to a heating step at 140° C. for 60 minutes before the sample was bonded thereto. The Sn content of ITO was calculated from (the weight of Sn atoms)/(the weight of Sn atoms+the weight of In atoms).

<Anti-Metal-Corrosion Properties>

An 8 mm×8 mm piece was cut from each pressure-sensitive adhesive layer attached polarizing film and used as a sample. A 15 mm×15 mm piece was cut from a conductive film (ELECRYSTA P400L (trade name) manufactured by Nitto Denko Corporation) with an ITO layer formed on the film surface. The sample was then bonded to the central part of the cut piece of the conductive film. The resulting laminate was autoclaved at 5 atm and 50° C. for 15 minutes and then used as a sample for the measurement of anti-corrosion properties. The resistance of the resulting measurement sample was measured with the measuring device shown below and designated as the “initial resistance.”

Subsequently, after the measurement sample was stored in an environment at 60° C. and 90% RH for 500 hours, the resistance of the sample was measured and designated as the “resistance after moist heating.” The resistance was measured with HL5500PC manufactured by Accent Optical Technologies Inc. A change in resistance was calculated from the measured initial resistance and the measured resistance after moist heating using the following formula:

$$Change in resistance = \frac{Resistance after moist heating}{Initial resistance} \qquad [ Formula ]$$

<Display Unevenness>

Two sample pieces with a size of 420 mm in length and 320 mm in width were cut from each pressure-sensitive adhesive layer attached polarizing film. Using a laminator, the sample pieces were bonded in a crossed-Nicols arrangement to both sides of a 0.07-mm-thick non-alkali glass sheet. The resulting laminate was then autoclaved at 5 atm and 50° C. for 15 minutes to form a secondary sample (initial). The secondary sample was then treated under the conditions of 90° C. for 24 hours (after heating). The initial secondary sample and the secondary sample after heating were each placed on a 10,000 cd backlight and visually evaluated for light leakage based on the following criteria.

(Evaluation Criteria)

⊙: There is neither corner unevenness nor practical problem.
◯: Corner unevenness slightly occurs but does not appear in the display region, and therefore, there is no practical problem.
Δ: Corner unevenness occurs and slightly appears in the display region, but there is no practical problem.
x: Corner unevenness occurs and significantly appears in the display region to cause a practical problem.

<Conductivity: Surface Resistance (Ω/□)>

After the separator film was peeled off from each pressure-sensitive adhesive layer attached polarizing film, the surface resistance (initial) of the pressure-sensitive adhesive surface was measured. In addition, after each pressure-sensitive adhesive layer attached polarizing film was stored in an environment at 60° C. and 95% RH for 500 hours and then dried at 40° C. for 1 hour, the separator film was peeled off from the pressure-sensitive adhesive layer. Subsequently, the surface resistance (after moist heating) of the pressure-sensitive adhesive surface was measured. The measurement was performed using MCP-HT450 manufactured by Mitsubishi Chemical Analytech Co., Ltd.

<Humidification-Induced Cloudiness>

A piece with a size of 50 mm×50 mm was cut from each pressure-sensitive adhesive layer attached polarizing film and then bonded to glass. A piece with a size of 50 mm×50 mm was also cut from a 25-μm-thick PET film (Diafoil T100-25B manufactured by Mitsubishi Plastics, Inc.) and then bonded to the upper surface of the polarizing film to form a measurement sample. The measurement sample was stored in an environment at 60° C. and 95% RH for 250 hours. Subsequently, 10 minutes after the sample was taken out to room temperature, the haze value of the sample was measured. The haze value was measured with Haze Meter HM150 manufactured by MURAKAMI COLOR RESEARCH LABORATORY CO., Ltd.

<Reworkability>

A 120-mm-long, 25-mm-wide piece was cut from each pressure-sensitive adhesive layer attached polarizing film and used as a sample. The sample was attached to a 0.7-mm-thick non-alkali glass sheet (EG-XG manufactured by Corning Incorporated) using a laminator. The sample was then autoclaved at 5 atm and 50° C. for 15 minutes to be completely bonded to the glass sheet. Subsequently, the adhering strength of the sample was measured. The adhering strength (N/25 mm, measurement length 80 mm) was measured by peeling the sample with a tensile tester (Shimadzu Autograph AG-1 10KN) at a peel angle of 900 and a peel rate of 300 mm/min. In the measurement, sampling was repeated at intervals of once per 0.5 s, and the average of the measured values was used for the evaluation.

| | | | | | | | | | Additives amount (wt parts) | | | | |
|---|---|---|---|---|---|---|---|---|---|---|---|---|---|
| (Meth) acryl-based polymer (A) | | | | | | | | | Crosslinking agent | | | | |
| Monomer content (wt %) | | | | | | | | | (B) | | | | |
| | | | | | | Additional | | | Isocyanate | | | Silane coupling | |
| (a3) | | | (a4) | (a5) | | monomer | Molecular weight | | type | | Peroxide | agent (C) | |
| [symbol] VP | NVC | AAM | AA | HBA | HEA | DMAEA | Mw | Mw/Mn | D160N | C/L | type | KBM403 | X-41-1056 |
| [symbol] .5 | | | 0.3 | 0.4 | | | 1,600,000 | 3.7 | 0.1 | | 0.3 | 0.2 | |
| [symbol] .5 | | | 0.3 | 0.4 | | | 1,550,000 | 3.5 | 0.1 | | 0.3 | 0.2 | |
| [symbol] .5 | | | 0.3 | 0.4 | | | 1,570,000 | 3.3 | 0.1 | | 0.3 | 0.2 | |
| [symbol] .5 | | | 0.3 | 0.4 | | | 1,600,000 | 3.6 | 0.1 | | 0.3 | 0.2 | |
| [symbol] .5 | | | 0.3 | 0.4 | | | 1,610,000 | 3.7 | 0.1 | | 0.3 | 0.2 | |
| [symbol] .5 | | | 0.3 | 0.4 | | | 1,570,000 | 3.7 | 0.1 | | 0.3 | 0.2 | |
| [symbol] 3 | | | 0.3 | 0.4 | | | 1,580,000 | 3.8 | 0.1 | | 0.3 | 0.2 | |
| [symbol] 5 | | | 0.3 | 0.4 | | | 1,560,000 | 3.5 | 0.1 | | 0.3 | 0.2 | |
| [symbol] 7 | | | 0.3 | 0.4 | | | 1,520,000 | 3.4 | 0.1 | | 0.3 | 0.2 | |
| | 1.5 | | 0.3 | 0.4 | | | 1,560,000 | 3.4 | 0.1 | | 0.3 | 0.2 | |
| | | 1.5 | 0.3 | 0.4 | | | 1,550,000 | 3.5 | 0.1 | | 0.3 | 0.2 | |
| [symbol] .5 | | | 0.05 | 0.4 | | | 1,550,000 | 3.5 | 0.1 | | 0.3 | 0.2 | |
| [symbol] .5 | | | 1 | 0.4 | | | 1,500,000 | 3.2 | 0.1 | | 0.3 | 0.2 | |
| [symbol] .5 | | | 0.3 | 1 | | | 1,600,000 | 3.7 | 0.1 | | 0.3 | 0.2 | |
| [symbol] .5 | | | 0.3 | | 1 | | 1,610,000 | 3.6 | 0.1 | | 0.3 | 0.2 | |
| [symbol] .5 | | | 0.3 | 0.4 | | | 1,570,000 | 3.3 | | 0.1 | 0.3 | 0.2 | |
| [symbol] .5 | | | 0.3 | 0.4 | | | 1,940,000 | 3.9 | 0.07 | | 0.2 | 0.2 | |
| [symbol] .5 | | | 0.3 | 0.4 | | | 1,420,000 | 3.6 | 0.12 | | 0.3 | 0.2 | |
| [symbol] .5 | | | 0.3 | 0.4 | | | 1,090,000 | 3.1 | 0.15 | | 0.3 | 0.2 | |
| [symbol] .5 | | | 0.3 | 0.4 | | | 1,580,000 | 2.1 | 0.1 | | 0.3 | 0.2 | |
| [symbol] .5 | | | 0.3 | 0.4 | | | 1,570,000 | 4.6 | 0.1 | | 0.3 | 0.2 | |
| [symbol] .5 | | | 0.3 | 0.4 | | | 1,540,000 | 8.6 | 0.1 | | 0.3 | 0.2 | |
| [symbol] .5 | | | 0.3 | 0.4 | | | 1,570,000 | 3.3 | 0.1 | | 0.3 | | |
| [symbol] .5 | | | 0.3 | 0.4 | | | 1,570,000 | 3.3 | 0.1 | | 0.3 | 0.2 | |
| [symbol] .5 | | | 0.3 | 0.4 | | | 1,570,000 | 3.3 | 0.1 | | 0.3 | 0.2 | |
| [symbol] .5 | | | 0.3 | 0.4 | | | 1,570,000 | 3.3 | 0.1 | | 0.3 | 0.2 | |
| [symbol] .5 | | | 0.3 | 0.4 | | | 1,570,000 | 3.3 | 0.1 | | 0.3 | 0.2 | |
| [symbol] .5 | | | 0.3 | 0.4 | | | 1,570,000 | 3.3 | 0.1 | | 0.3 | | 0.2 |
| [symbol] .5 | | | 0.3 | 0.4 | | | 1,570,000 | 3.3 | 0.1 | | 0.3 | | 0.2 |
| [symbol] .5 | | | 0.3 | 0.4 | | | 1,550,000 | 3.8 | 0.1 | | 0.3 | 0.2 | |
| | | | 0.3 | 0.4 | | | 1,540,000 | 3.5 | 0.1 | | 0.3 | 0.2 | |
| [symbol] .5 | | | 0.3 | 0.4 | | | 1,600,000 | 3.8 | 0.1 | | 0.3 | 0.2 | |
| | | | 0.3 | 0.4 | | | 1,590,000 | 3.7 | 0.1 | | 0.3 | 0.2 | |
| | | | 0.3 | 0.4 | | | 1,590,000 | 3.7 | 0.1 | | 0.3 | 0.2 | |
| [symbol] .0 | | | 0.3 | 0.4 | | | 1,550,000 | 3.5 | 0.1 | | 0.3 | 0.2 | |
| [symbol] .5 | | | | 0.4 | | | 1,600,000 | 3.9 | 0.1 | | 0.3 | 0.2 | |
| [symbol] .5 | | | 3 | 0.4 | | | 1,540,000 | 3.7 | 0.1 | | 0.3 | 0.2 | |
| [symbol] .5 | | | 0.3 | 4 | | | 1,580,000 | 3.5 | 0.1 | | 0.3 | 0.2 | |
| [symbol] .5 | | | 0.3 | 0.4 | | | 1,570,000 | 3.3 | | 4 | 0.3 | 0.2 | |
| [symbol] .5 | | | 0.3 | 0.4 | | | 800,000 | 3 | 0.2 | | 0.3 | 0.2 | |
| [symbol] .5 | | | 0.3 | 0.4 | | | 1,500,000 | 11.5 | 0.15 | | 0.3 | 0.2 | |
| | | | 0.3 | 0.4 | | 0.5 | 1,580,000 | 3.8 | 0.1 | | 0.3 | 0.2 | |
| | | | | | | | | | | | Additives amount (wt parts) | | |
| | | | | | | | | | | | Ionic compound | | |
| | | | | | | | | | | | (D) | | Poly- |
| | | | | | | | | | | | | EMP- | ether |
| | | | | | | | | | | | Li-TFSI | TFSI | (E) |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] 3 | | | |
| | | | | | | | | | | [symbol] 5 | | | |
| | | | | | | | | | | [symbol] 7 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | 0.5 | | |
| | | | | | | | | | | [symbol] .5 | 1 | | |
| | | | | | | | | | | [symbol] .5 | | 1 | |
| | | | | | | | | | | [symbol] .5 | | | 0.1 |
| | | | | | | | | | | [symbol] .5 | | | |
| | | | | | | | | | | [symbol] .5 | 1 | | |
| | | | | | | | | | | [symbol] .5 | | | |
| | | | | | | | | | | [symbol] .5 | | | |
| | | | | | | | | | | | 1 | | |
| | | | | | | | | | | [symbol] .0 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |
| | | | | | | | | | | [symbol] .5 | | | |

[symbol]

indicates data missing or illegible when filed

In Table 1, as to the monomers used for the preparation of the acryl-based polymer (A), BA represents butyl acrylate, PEA phenoxyethyl acrylate, NVP N-vinyl-pyrrolidone, NVC N-vinyl-ε-caprolactam, AAM acrylamide, AA acrylic acid, HBA 4-hydroxybutyl acrylate, and HEA 2-hydroxyethyl acrylate.

As to the crosslinking agent (B) of isocyanate type, D160N represents TAKENATE D160N (hexamethylene diisocyanate adduct of trimethylolpropane) manufactured by Mitsui Chemicals, Inc., and C/L represents CORONATE L (tolylene diisocyanate adduct of trimethylolpropane) manufactured by Nippon Polyurethane Industry Co., Ltd., and as to the crosslinking agent (B), “Peroxide type” means benzoyl peroxide (NYPER BMT manufactured by NOF CORPORATION).

As to the silane coupling agent (C), KBM403 represents KBM403 manufactured by Shin-Etsu Chemical Co., Ltd., and X-41-1056 represents X-41-1056 manufactured by Shin-Etsu Chemical Co., Ltd.

As to the ionic compound (D), Li-TFSI represents bis(trifluoromethanesulfonyl)imide lithium manufactured by Mitsubishi Materials Corporation, and EMP-TFSI represents 1-ethyl-1-methylpyrrolidinium bis(trifluoromethanesulfonyl)imide manufactured by Mitsubishi Materials Corporation.

“Polyether compound (E)” means SILYL SAT10 manufactured by KANEKA CORPORATION.

| [symbol] test | | | Durability test | | | | | | Durability test | | | | |
|---|---|---|---|---|---|---|---|---|---|---|---|---|---|
| [symbol] glass) | | | (crystalline ITO attached glass) | | | | | | (amorphous ITO attached glass) | | | | |
| [symbol] ification | | Heat | | | | Humidification | | Heat | | | | Humidification | |
| [symbol] | 60° C./ | shock | | | | 60° C./ | 60° C./ | shock | | | | 60° C./ | 60° C./ |
| [symbol] | 95% | −40 [symbol] | Heating | | | 90% | 95% | −40 [symbol] | Heating | | | 90% | 95% |
| [symbol] | RH | 85° C. | 80° C. | 85° C. | 90° C. | RH | RH | 85° C. | 80° C. | 85° C. | 90° C. | RH | RH |
| [symbol] | ⊙ | ⊙ | ⊙ | ⊙ | — | ⊙ | ⊙ | ⊙ | ⊙ | ⊙ | — | ⊙ | ◯ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | ◯ | ⊙ | ⊙ | ⊙ | ⊙ | ⊙ | ◯ | ⊙ | ⊙ |
| [symbol] | ⊙ | ⊙ | ⊙ | ⊙ | — | ⊙ | ⊙ | ⊙ | ⊙ | ◯ | — | ⊙ | ⊙ |
| [symbol] | ⊙ | ⊙ | ⊙ | ⊙ | — | ⊙ | ⊙ | ⊙ | ◯ | ◯ | — | ⊙ | ⊙ |
| [symbol] | ⊙ | ⊙ | ⊙ | ⊙ | — | ⊙ | ⊙ | ⊙ | ⊙ | ◯ | — | ⊙ | ◯ |
| [symbol] | ⊙ | ⊙ | ⊙ | ⊙ | — | ⊙ | ⊙ | ⊙ | ⊙ | ⊙ | | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | Δ | — | ⊙ | ◯ | Δ | ◯ | Δ | — | ◯ | Δ |
| [symbol] | ⊙ | ⊙ | ⊙ | ◯ | — | ⊙ | ⊙ | ◯ | ◯ | Δ | — | ⊙ | ◯ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ◯ | — | ⊙ | ⊙ | ◯ | ⊙ | ◯ | — | ⊙ | ⊙ |
| [symbol] | ⊙ | ⊙ | ⊙ | ◯ | | ◯ | ◯ | ◯ | ⊙ | Δ | — | ⊙ | ◯ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ◯ | — | ◯ | ◯ | ◯ | ⊙ | ◯ | — | ◯ | Δ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ⊙ | ⊙ | — | ⊙ | ⊙ | ⊙ | ⊙ | ⊙ | — | ⊙ | ⊙ |
| [symbol] | ⊙ | ⊙ | ◯ | ◯ | — | ⊙ | ⊙ | ⊙ | ◯ | ◯ | — | ⊙ | ⊙ |
| [symbol] | ◯ | ◯ | ◯ | ◯ | Δ | ◯ | Δ | ◯ | ◯ | Δ | Δ | ◯ | Δ |
| [symbol] | ⊙ | ⊙ | ⊙ | ⊙ | — | ⊙ | ⊙ | ⊙ | ⊙ | ⊙ | — | ⊙ | ⊙ |
| | | | | | | | Durability test | | | Conductivity | | | |
| | | | | | | | (amorphous ITO | Less | | Surface | | | |
| | | | | | | | attached glass) | metal- | | resistance | | | Rework- |
| | | | | | | | Heat | corrosive | | [Ω/□] | | Humid- | ability |
| | | | | | | | shock | properties | | | After | ification | Adhering |
| | | | | | | | −40 [symbol] | Change in | Display | | moist | induced | strength |
| | | | | | | | 85° C. | resistance | unevenness | Initial | heating | cloudiness | [N/25 mm] |
| | | | | | | | ⊙ | 1.22 | ◯ | — | — | ◯ | 6.5 |
| | | | | | | | ⊙ | 1.23 | ⊙ | — | — | ◯ | 5.8 |
| | | | | | | | ⊙ | 1.22 | ⊙ | — | — | ◯ | 5.7 |
| | | | | | | | ⊙ | 1.21 | ⊙ | — | — | ◯ | 5.7 |
| | | | | | | | ⊙ | 1.28 | ◯ | — | — | ◯ | 5.5 |
| | | | | | | | ◯ | 1.19 | ⊙ | — | — | ◯ | 4.5 |
| | | | | | | | ⊙ | 1.27 | ⊙ | — | — | ◯ | 7.2 |
| | | | | | | | ⊙ | 1.23 | ⊙ | — | — | ◯ | 8.5 |
| | | | | | | | ⊙ | 1.29 | ⊙ | — | — | ◯ | 9.8 |
| | | | | | | | ⊙ | 1.19 | ⊙ | — | — | ◯ | 5.3 |
| | | | | | | | Δ | 1.23 | ⊙ | — | — | ◯ | 6.1 |
| | | | | | | | Δ | 1.31 | ⊙ | — | — | ◯ | 4.7 |
| | | | | | | | ⊙ | 1.89 | ⊙ | — | | ◯ | 6.2 |
| | | | | | | | ⊙ | 1.22 | ⊙ | — | — | ◯ | 5.5 |
| | | | | | | | ◯ | 1.24 | ⊙ | — | — | ◯ | 5.2 |
| | | | | | | | Δ | 1.21 | ⊙ | — | — | ◯ | 5.3 |
| | | | | | | | ◯ | 1.22 | ⊙ | — | — | ◯ | 5.6 |
| | | | | | | | ⊙ | 1.25 | ⊙ | — | — | ◯ | 5.5 |
| | | | | | | | Δ | 1.26 | ⊙ | — | — | ◯ | 5.4 |
| | | | | | | | ⊙ | 1.24 | ⊙ | — | — | ◯ | 5.3 |
| | | | | | | | ⊙ | 1.26 | ⊙ | — | — | ◯ | 5.5 |
| | | | | | | | ⊙ | 1.25 | ⊙ | — | — | ◯ | 5.1 |
| | | | | | | | Δ | 1.22 | ⊙ | — | — | ◯ | 6.0 |
| | | | | | | | ⊙ | 1.22 | ⊙ | 1.0E+11 | 1.2E+11 | ◯ | 5.9 |

[symbol]

indicates data missing or illegible when filed

1. A pressure-sensitive adhesive composition for an optical film, the pressure-sensitive adhesive composition comprising:
(A) a (meth)acryl-based polymer comprising (a1) 70% by weight or more of a monomer unit derived from an alkyl (meth)acrylate, (a2) 3 to 25% by weight of a monomer unit derived from an aromatic ring-containing (meth)acrylate, (a3) 0.1 to 8% by weight of a monomer unit derived from an amide group-containing monomer, (a4) 0.01 to 2% by weight of a monomer unit derived from a carboxyl group-containing monomer, and (a5) 0.01 to 3% by weight of a monomer unit derived from a hydroxyl group-containing monomer, the (meth)acryl-based polymer (A) having a weight average molecular weight (Mw) of 1,000,000 to 2,500,000 and a weight average molecular weight (Mw)/number average molecular weight (Mn) ratio of 1.8 to 10; and
(B) a crosslinking agent,
the pressure-sensitive adhesive composition containing 0.01 to 3 parts by weight of the crosslinking agent (B) based on 100 parts by weight of the (meth)acryl-based polymer (A).

2. The pressure-sensitive adhesive composition for an optical film according to claim 1, wherein the amide group-containing monomer (a3) is an N-vinyl group-containing lactam monomer.

3. The pressure-sensitive adhesive composition for an optical film according to claim 1, wherein the hydroxyl group-containing monomer (a5) is 4-hydroxybutyl (meth)acrylate.

4. The pressure-sensitive adhesive composition for an optical film according to claim 1, wherein the crosslinking agent (B) comprises at least one selected from an isocyanate crosslinking agent and a peroxide crosslinking agent.

5. The pressure-sensitive adhesive composition for an optical film according to claim 4, wherein the isocyanate crosslinking agent comprises an aliphatic polyisocyanate compound.

6. The pressure-sensitive adhesive composition for an optical film according to claim 1, further comprising (C) a silane coupling agent.

7. The pressure-sensitive adhesive composition for an optical film according to claim 6, wherein the silane coupling agent (C) has two or more alkoxysilyl groups in a molecule.

8. The pressure-sensitive adhesive composition for an optical film according to claim 6, wherein the silane coupling agent (C) has an epoxy group in a molecule.

9. The pressure-sensitive adhesive composition for an optical film according to claim 6, which contains 0.001 to 5 parts by weight of the silane coupling agent (C) based on 100 parts by weight of the (meth)acryl-based polymer (A).

10. The pressure-sensitive adhesive composition for an optical film according to claim 1, further comprising (D) an ionic compound.

11. The pressure-sensitive adhesive composition for an optical film according to claim 10, wherein the ionic compound (D) is an alkali metal salt and/or an organic cation-anion salt.

12. The pressure-sensitive adhesive composition for an optical film according to claim 11, wherein the ionic compound (D) contains a fluoro group-containing anion.

13. The pressure-sensitive adhesive composition for an optical film according to claim 10, which contains 0.05 to 10 parts by weight of the ionic compound (D) based on 100 parts by weight of the (meth)acryl-based polymer (A).

14. The pressure-sensitive adhesive composition for an optical film according to claim 1, further comprising (E) a reactive silyl group-containing polyether compound.

15. The pressure-sensitive adhesive composition for an optical film according to claim 14, which contains 0.001 to 10 parts by weight of the reactive silyl group-containing polyether compound (E) based on 100 parts by weight of the (meth)acryl-based polymer (A).

16. A pressure-sensitive adhesive layer for an optical film, the pressure-sensitive adhesive layer comprising a product made from the pressure-sensitive adhesive composition according to claim 1.

17. A pressure-sensitive adhesive layer for an optical film attached optical film, comprising:
an optical film; and
the pressure-sensitive adhesive layer according to claim 16 formed on at least one side of the optical film.

18. An image display device comprising at least one piece of the pressure-sensitive adhesive layer attached optical film according to claim 17.

19. The pressure-sensitive adhesive composition for an optical film according to claim 2, wherein the hydroxyl group-containing monomer (a5) is 4-hydroxybutyl (meth)acrylate.

20. The pressure-sensitive adhesive composition for an optical film according to claim 2, wherein the crosslinking agent (B) comprises at least one selected from an isocyanate crosslinking agent and a peroxide crosslinking agent.
